(19) United States
(12) Patent Application Publication
(10) Pub. No.: US 2024/0007360 A1
(43) Pub. Date: Jan. 4, 2024

(54) VISUALIZATION FOR MIDDLEBOX RULE REALIZATION

(71) Applicant: VMware, Inc., Palo Alto, CA (US)

(72) Inventors: Pavan Vaidyula, Pune (IN); Tarang Khandelwal, Indore (IN); Pritesh Ramesh Gajjar, Pune (IN); Shrinivas Sharad Parashar, Pune (IN)

(21) Appl. No.: 17/984,476

(22) Filed: Nov. 10, 2022

(30) Foreign Application Priority Data
Jul. 1, 2022 (IN) 202241038019

(51) Int. Cl. H04L 41/22; G06F 3/0482; G06F 3/04847

(52) U.S. Cl. CPC H04L 41/22; G06F 3/0482; G06F 3/04847; G06F 2203/04803

(57) ABSTRACT

Some embodiments provide a method for displaying a visualization of a middlebox rule. Through a graphical user interface (GUI) that provides a visualization of middlebox rules, the method receives a selection of a particular middlebox rule defined for a network. In response to the selection, the method displays in the GUI a visualization of the particular middlebox rule that includes (i) a first display area for providing GUI items representing a set of source groups to which the particular middlebox rule is applied, (ii) a second display area for providing GUI items representing a set of services to which the particular middlebox rule is applied, and (iii) a third display area for providing GUI items representing a set of destination groups to which the particular middlebox rule is applied.

### BACKGROUND

In a software defined networking (SDN) environment, administrators can configure middlebox rules at multiple layers of a network, group middlebox rules into policies, and apply rules to groups of virtual machines (VMs). Currently, administrators collect and co-relate rule information manually, and there is no aggregated visualization that displays and co-relates information regarding a particular rule. As such, it can be difficult to identify more specific information about a given rule as well as how rules in a system relate to each other.

### BRIEF SUMMARY

Some embodiments provide a novel method for visualizing middlebox rules and groups of sources, destinations, and services to which the middlebox rules are applied. Through a graphical user interface (GUI) that provides a visualization of middlebox rules (e.g., firewall rules), a network visualization application (e.g., a network management application that provides network visualization information through its GUI) receives a selection of a particular middlebox rule defined for a network. In response to the selection, the method displays in the GUI a visualization of the particular middlebox rule that includes (1) a first display area for providing GUI items representing a set of source groups to which the particular middlebox rule is applied, (2) a second display area for providing GUI items representing a set of services to which the particular middlebox rule is applied, and (3) a third display area for providing GUI items representing destination groups to which the particular middlebox rule is applied.

In some embodiments, the particular middlebox rule is applied to data messages that have (1) a network address matching a member of at least one of the source groups, (2) a destination address matching a member of at least one of the destination groups, and (3) transport layer port numbers and a protocol value matching at least one of the set of services. The source groups and destination groups of some embodiments are security groups that a user has defined as either source or destination matching criteria for the middlebox rule.

Each member of a group may be a virtual machine (VM), a network address, a virtual interface (VIF), a logical port, a logical switch, or a different group. For instance, one group may include only VMs, while another group may include VMs and a group of logical ports (either added to the group individually or based on the addition of a logical switch). A group may also include one or more VIFs of a VM, but not all VIFs of that VM. A user may create source and destination groups based on any suitable criteria.

In some embodiments, a particular GUI item representing a particular group (i.e., a source or destination group) includes items representing each member of the particular group. For instance, different types of GUI items may be used to represent VMs, logical ports, network addresses, etc. Some embodiments, when possible, resolve each member to a VM (or container) if information to do so is stored by the network management application. In certain cases, when the particular group includes one VIF of a VM, the item representing the VIF includes an icon for the VM and an additional icon for the VIF. Upon receipt of a selection of the additional icon, the application displays in the GUI an additional display area indicating that the particular group includes only the one VIF of the VM and no other VIFs of the VM.

In certain cases, a group is too large (i.e., has too many members) for all of the members to be displayed at once in the GUI. In this situation, some embodiments display an item for the group that includes a subset of the group members as well as navigation items that allow a user to scroll through the other group members within the group item. In addition, upon receiving a selection of the GUI item representing this group, the application displays in the GUI another, larger display area (e.g., as a popover window) with items representing the group members. The larger display area is able to display many more items at once than the group item in the source or destination display area. In addition, if the group is still too large for all of the members to be represented at once, navigation items are provided enabling the user to scroll through all of the group members. Some embodiments also provide a search filter to allow a user to search for a particular member of the group. For instance, a user may use the search filter by typing in a name of a particular VM to find the VM.

As discussed above, a source or destination group may include another group as a member. For instance, a first group may include a second group as a member of the first group. In such embodiments, the particular middlebox rule may have been defined by an administrator to apply directly to both groups or the administrator may have only directly applied the rule to the first source group. However, even in the latter case, because the second group is a member of the first group, then if the first group is a source group the second group will also be a source group (and similarly for destination groups). In this situation, the second group is considered a derived group (i.e., a derived source group or derived destination group) and each member of the second group is considered a derived member of the first group, as the middlebox rule is applied to the members of the second group because each member of the second group is a member of the first group.

The display area that provides a first GUI item representing the first group may also provide a second GUI item representing the second group. In some embodiments, the second GUI item has a different appearance than the first GUI item in order to indicate that the second group is a derived (nested) group. For example, items representing derived groups may be displayed in a different color, bolded, shaded differently, etc. to differentiate from directly-defined groups. Upon receiving a selection of a GUI item representing a derived group, the application of some embodiments displays in the GUI another display area to display a hierarchy of the derived group (e.g., in the example above, showing that the second group is derived from the first group).

The services to which the middlebox rule is applied, in some embodiments, include sets of transport layer protocol (e.g., TCP, UDP, etc.) and port number sets that define different specific services (e.g., DHCP, ftp, http, https, etc.). Some embodiments display items for each service that indicate the transport layer protocol, source port(s), and destination port(s) for the service (in some cases the source and/or destination ports may be wildcarded).

In some embodiments, the set of services includes at least one derived service to which the particular middlebox rule is applied based on a definition of the particular middlebox rule that applies the particular middlebox rule to a higher-level service. Upon receiving a selection of a GUI item in the second display area representing the derived service, the method displays in the GUI another display area to display a hierarchy of the derived service that indicates that the derived service is derived from the higher-level service. For example, an administrator might define a rule as applying to dynamic host configuration protocol (DHCP) service, which includes both DHCP-client and DHCP-server services. The services display area would then display an item representing the DHCP-client service and a user selection of this item causes the GUI to present another display area to display a hierarchy showing that the DHCP-client service is derived from the DHCP service.

In some embodiments, in addition to the source, services, and destination display areas, the visualization of a middlebox rule includes a set of arrows from the first display area to the second display area and from the second display area to the third display area. The appearance of these arrows may indicate whether an action of the particular middlebox rule is allow, drop, or block (reject) data messages to which the particular middlebox rule is applied. For instance, the set of arrows may be a different color to represent the action associated with the middlebox rule, e.g., the set of arrows may be green to represent “allow,” orange to represent “drop,” and red to represent “block.” Any suitable appearance of the set of arrows may be used to represent the different actions of the displayed middlebox rule.

Middlebox rules (e.g., firewall rules) can, in some cases, be overridden by other rules with higher priority. For example, a first rule might allow all data messages from a particular source VM to another destination VM while a second, higher priority rule blocks data messages for a particular service from a group that includes the source VM to a group that includes the destination VM. In this example, the second rule overrides the first rule for data messages for the particular service.

In some embodiments, the GUI includes icons indicating that the rule is entirely overridden (or overrides another rule) or that the rule is overridden by (or overrides) a specific group and/or group member. For example, if the particular middlebox rule overrides another middlebox rule and/or is overridden by another middlebox rule, the GUI displays an icon indicating the override next to the rule name. If the middlebox rule is overridden for a particular group because of another middlebox rule (e.g., the other middlebox rule drops data messages sent from members of the particular group whereas the visualized rule allows data messages sent from members of the particular group), the GUI displays an icon indicating this override along with the GUI item representing the particular group. If the middlebox rule is overridden for a particular individual group member because of another middlebox rule, the GUI displays an icon indicating this override along with the icon representing the particular member. Upon receiving a selection of an icon indicating an override, the application may display in the GUI another display area describing that the particular middlebox rule, the particular group, or the particular group member is being overridden by or overriding another middlebox rule. For example, if a user selects an override icon displayed next to the particular middlebox rule's name, the GUI displays a new display area to describe which other middlebox rule is overriding or is being overridden by the particular middlebox rule.

The GUI of some embodiments may also display a set of filters for a user to select types of group members and types of services to display in the GUI. Upon selection of one or more member types or services, the method generates a new visualization including representations of only members or services that match the selected member types or services. For instance, the set of filters may include selectable items to select network addresses, VMs, derived VMs, overridden VMs, derived services, etc. A user may select one or more of these selectable items to include only those member types or services in the visualization. In some embodiments, the GUI also includes a search filter for a user to search for a particular member of a group or a particular service in the visualization. For instance, a user may use the search filter by typing in a name of a particular VM to find the VM in the visualization and to find which group or groups to which the VM belongs.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a process of some embodiments to generate a visualization in a GUI of information regarding a particular middlebox rule.

FIGS. 2A-B illustrate an example GUI for visualizing information regarding a particular middlebox rule selected through the GUI by a user.

FIG. 3 illustrates an example GUI for visualizing a particular group too large to display in a group GUI item.

FIG. 4 illustrates an example GUI for visualizing a particular middlebox rule that is being overridden by or overriding another middlebox rule.

FIG. 5 illustrates an example GUI for visualizing information associated with a selected middlebox rule based on a displayed set of filters.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for visualizing middlebox rules and groups of sources, destinations, and services to which the middlebox rules are applied. Through a graphical user interface (GUI) that provides a visualization of middlebox rules (e.g., firewall rules), a network visualization application (e.g., a network management application that provides network visualization information through its GUI) receives a selection of a particular middlebox rule defined for a network. In response to the selection, the method displays in the GUI a visualization of the particular middlebox rule that includes (1) a first display area for providing GUI items representing a set of source groups to which the particular middlebox rule is applied, (2) a second display area for providing GUI items representing a set of services to which the particular middlebox rule is applied, and (3) a third display area for providing GUI items representing destination groups to which the particular middlebox rule is applied.

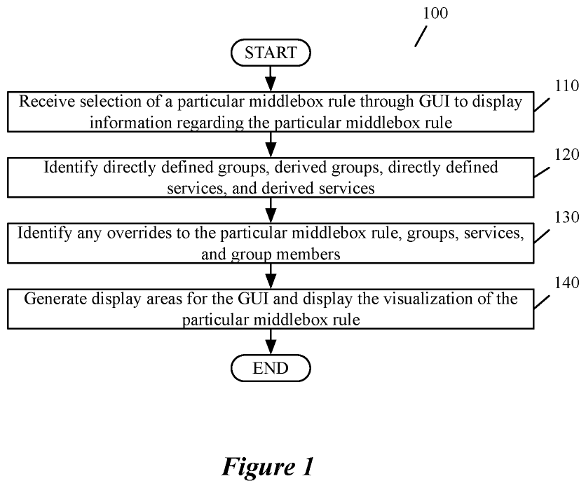

FIG. 1 conceptually illustrates a process 100 of some embodiments for generating a GUI to display information for a particular middlebox rule (e.g., a firewall rule, an intrusion detection and/or prevention rule, etc.). This process 100 may be performed by a network visualization application, network management application, or any suitable application that provides network visualization information to a user through its GUI.

The process 100 begins by receiving (at 110) a selection of a particular middlebox rule through the GUI to display information regarding the particular middlebox rule. The network visualization application may present one or more middlebox rules to a user through the GUI (e.g., by showing a list of rules, by displaying a rule or set of rules that have been applied to a data message in a network, etc.), and the user may select one of these middlebox rules to view more information regarding the selected middlebox rule. In some embodiments, multiple types of middlebox rules are applied in the network, and the user can view the policies and rules for each different middlebox or logical middlebox (e.g., distributed firewalls, gateway firewall, intrusion prevention/detection, etc.).

Next, the process 100 identifies (at 120) directly defined groups, derived groups, directly defined services, and derived services associated with the particular middlebox rule. In some embodiments, the particular middlebox rule is applied to data messages that have (1) a network address matching a member of at least one of a set of source groups, (2) a destination address matching a member of at least one of a set of destination groups, and (3) transport layer port numbers and a protocol value matching at least one of a set of services.

The source groups and destination groups of some embodiments are security groups that a user has defined as either source or destination matching criteria for the middlebox rule. In some embodiments, a source or destination group may include another group as a member. For instance, a first group may include a second group as a member of the first group. In such embodiments, the particular middlebox rule may have been defined by an administrator to apply directly to both groups or the administrator may have only directly applied the rule to the first source group. However, even in the latter case, because the second group is a member of the first group, then if the first group is a source group the second group will also be a source group (and similarly for destination groups). In this situation, the second group is considered a derived group (i.e., a derived source group or derived destination group) and each member of the second group is considered a derived member of the first group, as the middlebox rule is applied to the members of the second group because each member of the second group is a member of the first group. The network application of some embodiments identifies each of these directly defined and derived source and destination groups for the particular middlebox rule.

Correspondingly, services associated with the particular middlebox rule may include at least one derived service to which the particular middlebox rule is applied based on a definition of the particular middlebox rule that applies the particular middlebox rule to a higher-level service. For example, an administrator might define a rule as applying to dynamic host configuration protocol (DHCP) service, which includes both DHCP-client and DHCP-server services as derived services (using different destination port numbers). The network application of some embodiments identifies each of these directly defined and derived services for the particular middlebox rule.

Next, the process 100 identifies (at 130) any overrides to the particular middlebox rule, groups, services, and group members. Middlebox rules (e.g., firewall rules) can, in some cases, be overridden by other rules with higher priority, or can override other rules with lower priority. For example, a first rule might allow all data messages from a particular source VM to another destination VM while a second, higher priority rule blocks data messages for a particular service from a group that includes the source VM to a group that includes the destination VM. In this example, the second rule overrides the first rule for data messages for the particular service. In some embodiments, the particular middlebox rule is overridden for a particular group, a particular service, or a particular group member because of another middlebox rule. The network visualization application identifies any of these overrides, if any, to display this information in the GUI.

Finally, the process 100 generates (at 140) display areas for the GUI and displays the visualization of the particular middlebox rule, then ends. Display areas for the source groups, services, and destination groups may be generated to display a visualization of each group and service to the user. Display areas for any identified overrides may be generated. In some embodiments, these display areas may be displayed along with the group and service display areas, while, in other embodiments, these display areas may only be displayed upon selection from the user of a GUI item representing the overrides. Examples of these display areas will now be described.

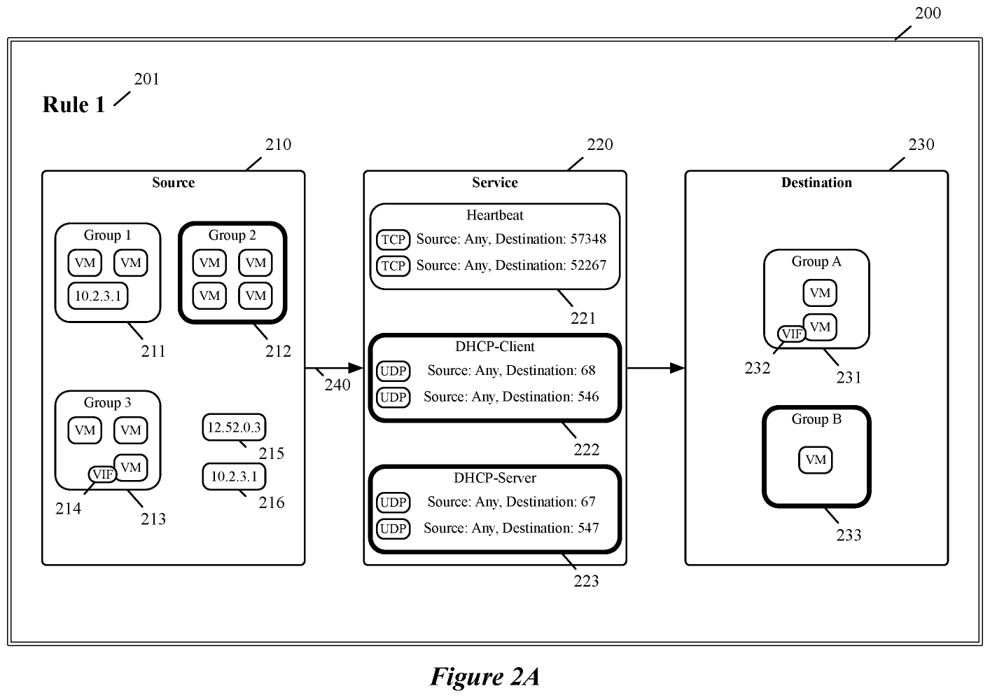

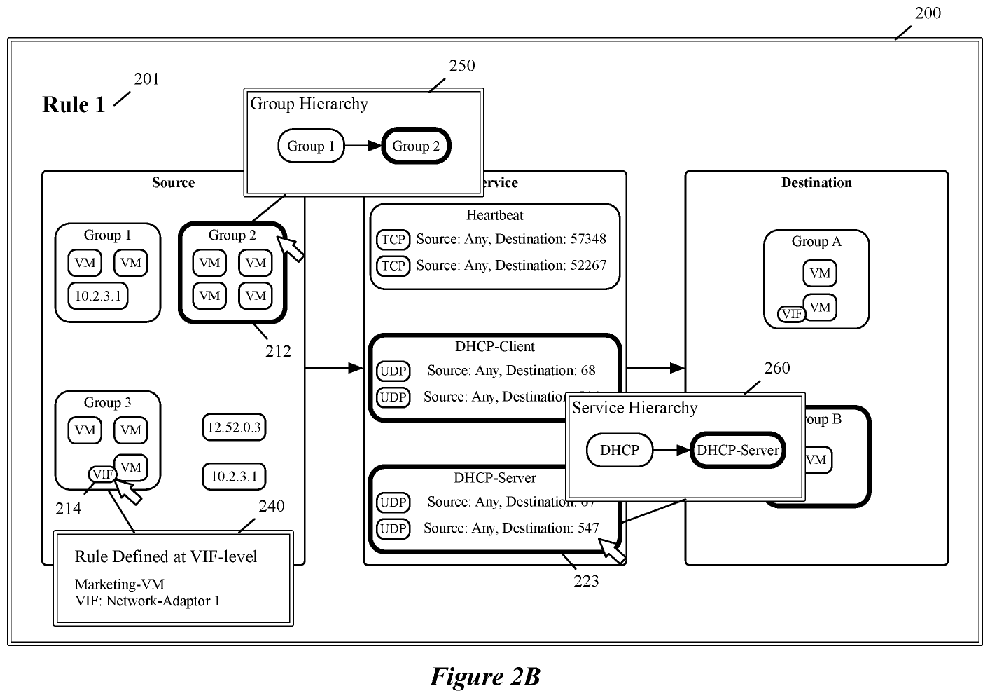

FIG. 2A illustrates an example GUI 200 of some embodiments for visualizing information regarding a particular middlebox rule selected through the GUI by a user. upon selection of a middlebox rule, a network visualization application presents the GUI 200 to a user for the user to view information regarding source and destination groups and services associated with the selected middlebox rule. The selected middlebox rule's name 201 (e.g., as specified by the administrator that defined the rule) is displayed in the GUI 200.

In some embodiments, the GUI 200 displays a first display area 210 for source groups, a second display area 220 for services, and a third display area 230 for destination groups. Each display area includes a GUI item for each group or service to be displayed. The display areas 210-230 in some embodiments are connected by a set of arrows 240 from the first display area 210 to the second display area 220 and from the second display area 220 to the third display area 230. The appearance of these arrows 240 may indicate an action specified for the displayed middlebox rule (i.e., the action applied to data messages matching the rule). For instance, the appearance could be different whether the action specifies to allow, drop, or block (reject) data messages to which the displayed middlebox rule 201 is applied. As an example, the set of arrows 240 may be a different color to represent the action associated with the selected middlebox rule 201 (e.g., green to represent “allow,” orange to represent “drop,” and red to represent “block”). Any suitable appearance of the set of arrows 240 may be used to represent the different actions of the displayed middlebox rule 201.

Each member of a group may be a VM, a network address, a virtual interface (VIF), a logical port, a logical switch, or a different group. For instance, one group may include only VMs, while another group may include VMs and a group of logical ports (either added to the group individually or based on the addition of a logical switch). A particular GUI item representing a particular group (i.e., a source or destination group) may include items representing each member of the particular group. For instance, different types of GUI items may be used to represent VMs, logical ports, network addresses, etc. Some embodiments, when possible, resolve each member to a VM (or container or other data compute node) if information to do so is stored by the network management application.

In this example, the first display area 210 displays three source groups using three GUI items 211-213. Group 1 in GUI item 211 is shown to include three items representing two VMs and an Internet Protocol (IP) address. Group 2 in GUI item 212 is shown to include four items representing all VMs. A group may also include one or more VIFs of a VM, but not all VIFs of that VM. In certain cases, when the particular group includes one or more VIFs of a VM, the item representing that group member includes an icon for the VM and an additional icon for the VIF. For instance, Group 3 in GUI item 213 is shown to include three items, two of which represent VMs. The third item 214 includes two icons to represent a VIF of a VM, indicating that the group includes one or more VIFs of the VM, but not all VIFs of the VM. Upon receipt of a selection of the additional icon, a network visualization application may display in the GUI an additional display area indicating that the particular group includes only the one VIF of the VM and no other VIFs of the VM.

Though not shown in this example, some embodiments display the name and/or network address (e.g., IPv4 and/or IPv6 address, MAC address, etc.) of each VM along with the item representing that VM. In some cases, an administrator may define a rule to be applied directly to a specific network address (e.g., IP address) or may add a network address directly to a group. The GUI items 215 and 216 are examples of items used to represent such network addresses. Some embodiments display these types of items (showing only the network address) for all network addresses to which a rule is directly applied or that are directly added to a group while other embodiments display these items only if the network visualization application is unable to resolve the network address to a VM or other data compute node. In this example, it should be noted, the rule is directly applied to IP address 10.2.3.1 in addition to being applied to Group 1 (which includes the IP address).

FIG. 2B illustrates the example GUI 200 after selection of various items presented in the GUI 200. In some embodiments, a user clicks on or hovers a mouse over the icon 214 representing the VIF, and, in response, the GUI 200 displays another display area 240. This additional display area 240 presents to the user the additional information that Group 3 includes only one VIF of a VM, and no other VIFs of the VM. A similar display area may be displayed in the GUI for any other additional icon in a GUI item representing a source or destination group, such as the additional icon 232 shown in destination Group A represented by the GUI item 231.

In some embodiments, GUI items representing derived groups and services may be displayed in a different color, bolded, shaded differently, etc. to differentiate from GUI items representing directly-defined groups. Any suitable appearance of derived groups and services may be used. In the example illustrated in FIG. 2A, derived groups and services are bolded. The source display area 210 displays Group 2 in the GUI item 212 which is bolded in order to differentiate it from the other source group GUI items 211 and 213, indicating that Group 2 is a derived group.

Upon receiving a selection of a GUI item representing a derived group (e.g., from a user hovering a mouse over or clicking on a derived group GUI item), the network visualization application of some embodiments displays in the GUI another display area to display a hierarchy of the derived group (e.g., in the example above, showing that the second group is derived from the first group). For instance, when a user selects the GUI item 212 for the derived Group 2, the GUI 200 displays another display area 250, shown in FIG. 2B. This display area 250 presents a group hierarchy of the selected derived group and any other groups from which it derives. In the example of Group 2 represented by GUI item 212, the display area 250 displays that Group 2 is a nested group of Group 1. Upon receiving this information, a user may understand that because the displayed middlebox rule 201 is directly applied to Group, and because Group 2 is a nested group of Group 1, Group 2 is a derived group and thus the displayed middlebox rule 201 is applied to Group 2. A similar display area may be displayed for any derived source or destination group, such as destination Group B displayed in GUI item 233.

FIG. 2A also illustrates GUI items 221-223 representing services. The services to which the middlebox rule is applied, in some embodiments, include sets of transport layer protocol (e.g., TCP, UDP, etc.) and port number sets that define different specific services (e.g., DHCP, ftp, http, https, etc.). Some embodiments display items for each service that indicate the transport layer protocol, source port(s), and destination port(s) for the service (in some cases the source and/or destination ports may be wildcarded).

Each GUI item 221-223 in some embodiments displays the name of the service, the protocol, and the source and destination ports. For instance, the GUI item 221 representing heartbeat services displays transmission control protocol (TCP), any source port, and destination ports 57348 and 52267. This GUI item 221 represents a directly applied service. The GUI items 222 and 223 are bolded and hence represent derived services. Upon receiving a selection of a GUI item in the service display area 220 representing a derived service (e.g., from a user hovering a mouse over or clicking on a derived service GUI item), the network visualization application of some embodiments displays in the GUI 200 another display area 260, as shown in FIG. 2B. This display area presents a hierarchy of the derived service that indicates that the derived service is derived from the higher-level service. In the example of the DHCP-Server service group represented by the GUI item 223, the display area 260 presents to the user that the DHCP-Server service is derived from a DHCP service. This information indicates that an administrator defined the displayed middlebox rule 201 as applying to DHCP service, which includes both DHCP-client and DHCP-server services. A similar display area may be displayed for the DHCP-Client service represented by the GUI item 222, upon selection of this GUI item 222 from the user. It should also be noted that, while this figure shows multiple additional display areas, in some embodiments only one of these display areas is actually displayed in the GUI at one time. In other embodiments, the GUI can display multiple additional display areas over the initial visualization.

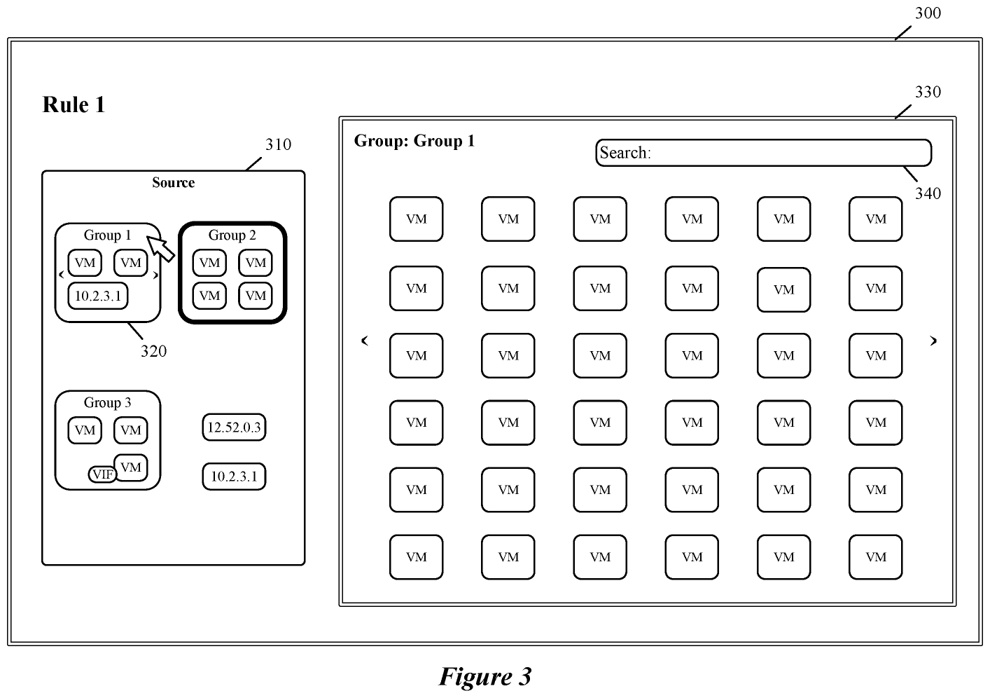

In some embodiments, a group is too large (i.e., has too many members) for all of the members to be displayed at once in the GUI. In this situation, some embodiments display an item for the group that includes a subset of the group members as well as navigation items that allow a user to scroll through the other group members within the group item. FIG. 3 illustrates an example GUI 300 that includes a source group 310 too large to display an item for each member in the source display area 310. As shown, the GUI item 320 representing this group includes scroll arrows that can be selected to navigate through the members of the group.

In addition, upon receiving a selection of the GUI item 320 representing this group, the network visualization application may display in the GUI 300 another, larger display area 330 (e.g., as a popover window) with items representing the group members. The larger display area 330 is able to display many more items at once than the group item 320 in the source display area 310. In addition, because this group is still too large for all of the members to be represented at once, navigation items (scroll arrows in this case) are provided in some embodiments enabling the user to scroll through all of the group members. Some embodiments also provide a search filter 340 to allow a user to search for a particular member of the group. For instance, a user may use the search filter by typing in a name of a particular VM to find the VM in the group. A similar display area may be displayed for any source or destination group too large to display items for each member.

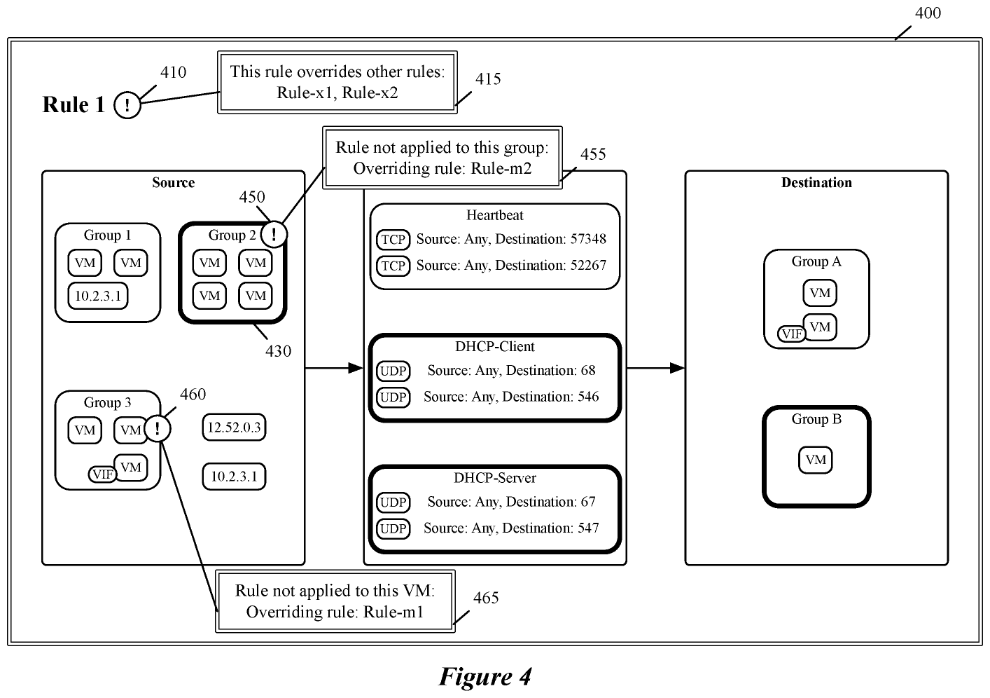

FIG. 4 illustrates another example GUI 400 with an overriding middlebox rule, an overridden group, and an overridden group member. Middlebox rules (e.g., firewall rules) can, in some cases, be overridden by other middlebox rules with higher priority. For example, a first rule might allow all data messages from a particular source VM to another destination VM while a second, higher priority rule blocks data messages for a particular service from a group that includes the source VM to a group that includes the destination VM. In this example, the second rule overrides the first rule for data messages for the particular service. In some embodiments, the GUI includes icons indicating that the rule is entirely overridden (or overrides another rule) or that the rule is overridden by (or overrides) a specific group and/or group member. For example, if the particular middlebox rule overrides another middlebox rule and/or is overridden by another middlebox rule, the GUI displays an icon indicating the override next to the rule name. If the middlebox rule is overridden for a particular group because of another middlebox rule (e.g., the other middlebox rule drops data messages sent from members of the particular group whereas the visualized rule allows data messages sent from members of the particular group), the GUI displays an icon indicating this override along with the GUI item representing the particular group.

In the example of FIG. 4, the GUI 400 includes an icon 410 indicating that the displayed middlebox rule is overriding two other rules, Rule-x1 and Rule-x2. That is, Rule-x1 and Rule-x2 are either never applied or at least not applied to certain groups or group members in the current network configuration because Rule 1 has the same or overlapping match conditions and a higher priority. Upon receiving a selection of this icon 410 representing a middlebox rule override (e.g., from a user hovering a mouse over or clicking on the icon 410), the network visualization application of some embodiments displays in the GUI 400 another display area 415. In this display area 415, the GUI 400 presents to the user which rules the displayed middlebox rule is being overridden by or is overriding.

If the displayed middlebox rule is overridden for a particular source or destination group, the GUI 400 displays an icon 450 next to the affected group represented by the GUI item 430 indicating this override. Upon selection of this icon 450, the GUI 400 displays a display area 455 to present to the user which rules are being overridden by or are overriding the displayed middlebox rule for the affected group. In this example, the displayed middlebox rule is not being applied to any member of Group 2 because of an overriding rule Rule-m2 with higher priority. For example, Rule-m2 could be applied to all data messages with source addresses in Group 2, irrespective of the destination or service. In some embodiments, an overriding rule might only override another rule for a subset of data messages. For instance, if Rule-m2 is applied to all heartbeat data messages sent by members of Group 2, then Rule 1 is overridden for these messages but not for DHCP messages sent by members of Group 2.

If the displayed middlebox rule is overridden for one or more particular members of a group, but not all members of a group, the GUI 400 displays an icon 460 next to the affected group member to indicate the override. Upon selection of this icon 460, the GUI 400 displays a display area 465 to present to the user which rules are being overridden by or are overriding the displayed middlebox rule for the affected group member. In this example, the displayed middlebox rule is not being applied to a particular VM of Group 3 because of an overriding rule Rule-m1 with higher priority.

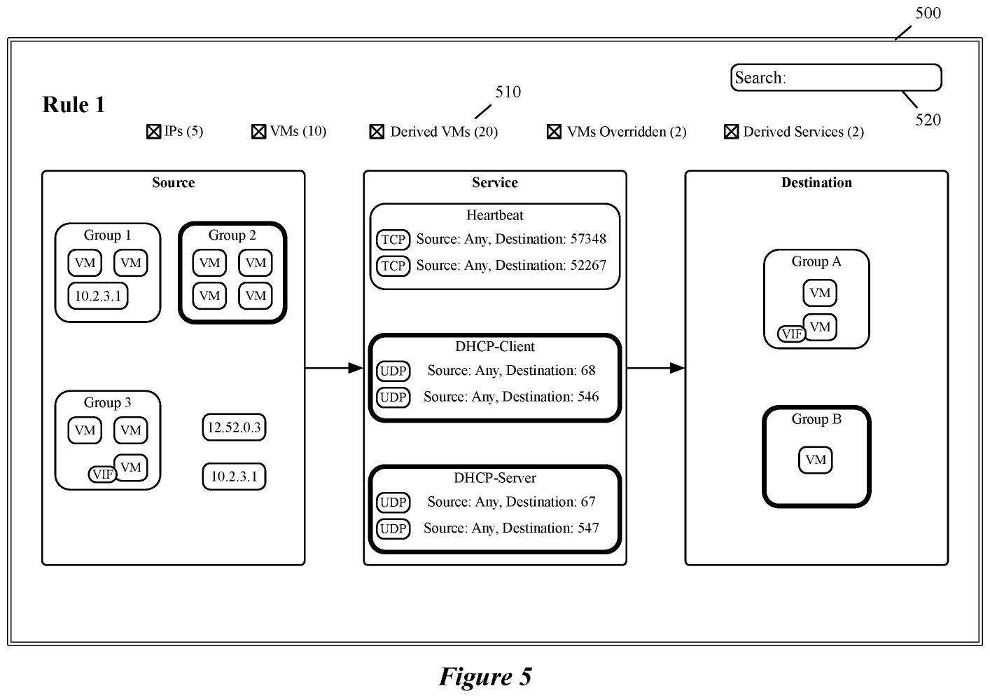

In some embodiments, a GUI presenting information for a selected middlebox rule also displays a set of filters for a user to select types of group members and types of services to display in the GUI. The example of FIG. 5 illustrates a GUI 500 that includes a set of filters 510. The set of filters 510 may be selected such that only selected components are displayed in the visualization. For instance, upon selection of one or more member types or services using the set of filters 510, the network visualization application generates a new visualization in the GUI 500 including representations of only members or services that match the selected member types or services. The set of filters 510 may include selectable items to select network addresses, VMs, derived VMs, overridden VMs, derived services, etc. A user may select one or more of these selectable items to include only those member types or services in the visualization.

In the example of FIG. 5, a user has selected all selectable items to view all member types and services in the GUI 500. When the user deselects one or more selectable items, the GUI 500 changes to not include members and/or services of the deselected type. For example, if the user deselects the “VMs” selectable item in the set of filters 510, a network visualization application would generate a new visualization that does not present any VMs in the GUI 500. If the user deselects the “Derived Services” selectable item, the network visualization application would generate a new visualization that does not present derived services in the GUI 500. In some embodiments, if the “Derived Services” selectable item is deselected, no GUI items are displayed for the derived services. In other embodiments, an empty GUI item may be displayed for each derived service to still indicate in the services display area that there are derived services to which the displayed middlebox rule is applied.

Each selectable item in the set of filters 510 in some embodiments also indicates how many of that member type or service is associated with the displayed middlebox rule. For example, the set of filters 510 displays that there are 5 IP addresses, 10 VMs, 20 derived VMs, 2 overridden VMs, and 2 derived services associated with the displayed middlebox rule. In some embodiments, the GUI also includes a search filter 520 for the user to search for a particular member of a group or a particular service displayed in the GUI 500. For instance, the user may use the search filter 520 by typing in a name of a particular VM to find the VM in the GUI 500 and to find which group or groups to which the VM belongs. In some embodiments, the searched VM may be highlighted in the GUI 500 for the user to find the VM in the GUI 500. In other embodiments, the GUI 500 may remove all icons representing VMs except for the searched VM for the user to find the VM in the GUI 500.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

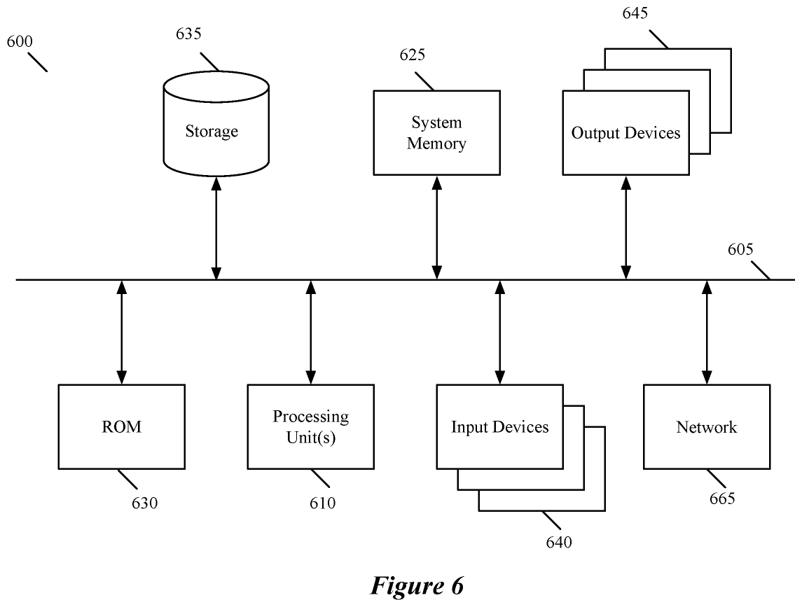

FIG. 6 conceptually illustrates a computer system 600 with which some embodiments of the invention are implemented. The computer system 600 can be used to implement any of the above-described computers and servers. As such, it can be used to execute any of the above described processes. This computer system includes various types of non-transitory machine readable media and interfaces for various other types of machine readable media. Computer system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the computer system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments. The read-only-memory (ROM) 630 stores static data and instructions that are needed by the processing unit(s) 610 and other modules of the computer system. The permanent storage device 635, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 635.

Other embodiments use a removable storage device (such as a flash drive, etc.) as the permanent storage device. Like the permanent storage device 635, the system memory 625 is a read-and-write memory device. However, unlike storage device 635, the system memory is a volatile read-and-write memory, such a random access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the computer system. The input devices 640 include alphanumeric keyboards and pointing devices (also called “cursor control devices”). The output devices 645 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples computer system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of computer system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method comprising:
through a graphical user interface (GUI) that provides a visualization of middlebox rules, receiving a selection of a particular middlebox rule defined for a network; and
in response to the selection, displaying in the GUI a visualization of the particular middlebox rule that comprises (i) a first display area for providing GUI items representing a set of source groups to which the particular middlebox rule is applied, (ii) a second display area for providing GUI items representing a set of services to which the particular middlebox rule is applied, and (iii) a third display area for providing GUI items representing a set of destination groups to which the particular middlebox rule is applied.

2. The method of claim 1, wherein the particular middlebox rule is applied to data messages that have (i) a network address matching a member of at least one of the source groups, (ii) a destination address matching a member of at least one of the destination groups, and (iii) transport layer port numbers and a protocol value matching at least one of the set of services.

3. The method of claim 1, wherein the source groups and destination groups each comprise a set of members, wherein each member is one of a virtual machine (VM), a network address, a virtual interface (VIF), a logical port, a logical switch, and a different group.

4. The method of claim 3, wherein a particular GUI item representing a particular group comprises items representing each member of the particular group.

5. The method of claim 4, wherein:
the particular group comprises a VIF that is one VIF of a VM that has a plurality of VIFs;
the item representing the VIF comprises an icon for the VM and an additional icon for the VIF; and
the method further comprises, upon receipt of a selection of the additional icon, displaying in the GUI a fourth display area indicating that the particular group includes only the one VIF of the VM and no other VIFs of the VM.

6. The method of claim 4, wherein:
the particular group is a first group; and
a second group comprises a number of members such that items representing all of the members of the second group cannot be displayed within the GUI item representing the second group; and
the method further comprises, upon receiving a selection of the GUI item representing the second group, displaying in the GUI a fourth display area comprising items representing each member of the second group.

7. The method of claim 6, wherein the fourth display area further comprises a filter for a user to search for a particular member of the second group.

8. The method of claim 3, wherein:
a first group represented by a first GUI item comprises a second group; and
the display area that provides the first GUI item also provides a second GUI item representing the second group; and
the second GUI item has a different appearance than the first GUI item in order to indicate that the second group is a nested group derived from one of the other groups.

9. The method of claim 8 further comprising:
receiving a selection of the second GUI item representing the second group; and
displaying in the GUI a fourth display area to display a hierarchy of the second group that indicates that the second group is derived from the first group.

10. The method of claim 1, wherein the set of services comprises at least one derived service to which the particular middlebox rule is applied based on a definition of the particular middlebox rule that applies the particular middlebox rule to a higher-level service.

11. The method of claim 10 further comprising:
receiving a selection of a particular GUI item in the second display area representing the derived service; and
displaying in the GUI a fourth display area to display a hierarchy of the derived service that indicates that the derived service is derived from the higher-level service.

12. The method of claim 1, wherein the GUI displays a set of arrows from the first display area to the second display area and from the second display area to the third display area, wherein an appearance of the set of arrows indicates whether an action of the particular middlebox rule is allow, drop, or block data messages to which the particular middlebox rule is applied.

13. The method of claim 1, wherein the GUI displays an icon indicating an override for at least one of (i) the particular middlebox rule, (ii) a particular group, and (iii) a particular member of one of the groups.

14. The method of claim 13 further comprising:
receiving a selection of the icon indicating the override; and
displaying in the GUI a fourth display area describing that the particular middlebox rule, particular group, or particular group member is being overridden by or overriding another middlebox rule.

15. The method of claim 1, wherein:
the GUI displays a set of filters for a user to select types of group members and types of services to display in the GUI; and
the method further comprises, upon selection of one or more member types or services, generating a new visualization comprising representations of only members or services that match the selected member types or services.

16. The method of claim 1, wherein each source group in the set of source groups and each destination group in the set of destination groups is a security group comprising a plurality of members.

17. A non-transitory machine-readable medium storing a program for execution by at least one processing unit, the program comprising sets of instructions for:
through a graphical user interface (GUI) that provides a visualization of middlebox rules, receiving a selection of a particular middlebox rule defined for a network; and
in response to the selection, displaying in the GUI a visualization of the particular middlebox rule that comprises (i) a first display area for providing GUI items representing a set of source groups to which the particular middlebox rule is applied, (ii) a second display area for providing GUI items representing a set of services to which the particular middlebox rule is applied, and (iii) a third display area for providing GUI items representing a set of destination groups to which the particular middlebox rule is applied.

18. The non-transitory machine-readable medium of claim 1, wherein:
the source groups and destination groups each comprise a set of members, wherein each member is one of a virtual machine (VM), a network address, a virtual interface (VIF), a logical port, a logical switch, and a different group; and
a particular GUI item representing a particular group comprises items representing each member of the particular group.

19. The non-transitory machine-readable medium of claim 18, wherein:
the particular group comprises a VIF that is one VIF of a VM that has a plurality of VIFs;
the item representing the VIF comprises an icon for the VM and an additional icon for the VIF; and
the program further comprises a set of instructions for displaying in the GUI a fourth display area indicating that the particular group includes only the one VIF of the VM and no other VIFs of the VM upon receipt of a selection of the additional icon.

20. The non-transitory machine-readable medium of claim 18, wherein:
the particular group is a first group; and
a second group comprises a number of members such that items representing all of the members of the second group cannot be displayed within the GUI item representing the second group; and
the program further comprises a set of instructions for displaying in the GUI a fourth display area comprising items representing each member of the second group upon receiving a selection of the GUI item representing the second group.

21. The non-transitory machine-readable medium of claim 18, wherein:
a first group represented by a first GUI item comprises a second group; and
the display area that provides the first GUI item also provides a second GUI item representing the second group; and
the second GUI item has a different appearance than the first GUI item in order to indicate that the second group is a nested group derived from one of the other groups.

22. The non-transitory machine-readable medium of claim 21, wherein the program further comprises sets of instructions for:
receiving a selection of the second GUI item representing the second group; and
displaying in the GUI a fourth display area to display a hierarchy of the second group that indicates that the second group is derived from the first group.

23. The non-transitory machine-readable medium of claim 17, wherein the set of services comprises at least one derived service to which the particular middlebox rule is applied based on a definition of the particular middlebox rule that applies the particular middlebox rule to a higher-level service, the program further comprising sets of instructions for:
receiving a selection of a particular GUI item in the second display area representing the derived service; and
displaying in the GUI a fourth display area to display a hierarchy of the derived service that indicates that the derived service is derived from the higher-level service.

24. The non-transitory machine-readable medium of claim 17, wherein the GUI displays an icon indicating an override for at least one of (i) the particular middlebox rule, (ii) a particular group, and (iii) a particular member of one of the groups, the program further comprising sets of instructions for:
receiving a selection of the icon indicating the override; and
displaying in the GUI a fourth display area describing that the particular middlebox rule, particular group, or particular group member is being overridden by or overriding another middlebox rule.

25. The non-transitory machine-readable medium of claim 17, wherein:
the GUI displays a set of filters for a user to select types of group members and types of services to display in the GUI; and
the program further comprises a set of instructions for generating, upon selection of one or more member types or services, a new visualization comprising representations of only members or services that match the selected member types or services.
